(19) United States
(12) Patent Application Publication
(10) Pub. No.: US 2026/0169289 A1
(43) Pub. Date: Jun. 18, 2026

(54) AN OPTICAL DEVICE FOR MODIFYING LIGHT DISTRIBUTION

(71) Applicant: Ledil Oy, SALO (FI)

(72) Inventor: Olli SAARNIO, SALO (FI)

(21) Appl. No.: 19/127,142

(22) PCT Filed: Oct. 6, 2023
(86) PCT No.: PCT/FI2023/050575

§ 371 Date: May 5, 2025

(30) Foreign Application Priority Data
Nov. 29, 2022 (FI) 20226062

(51) Int. Cl. G02B 27/01; F21V 8/00; G02B 6/42; G02B 19/00

(52) U.S. Cl. CPC G02B 27/0101; F21V 5/008; F21V 7/0091; F21V 14/06; G02B 6/0051; G02B 6/0068; G02B 6/4214; G02B 19/0028

(57) ABSTRACT

An optical device comprises a first optical element (101), a second optical element (102), and a third optical element (103). The first optical element is rotatable with respect to the second optical element around a geometric optical axis (108) of the optical device, and the third optical element is linearly moveable with respect to the second optical element along the geometric optical axis. The first and second optical elements comprise surfaces (104, 105) facing towards each other for changing a width of a light distribution pattern in two perpendicular directions in response to rotating the first optical element with respect to the second optical element. The second and third optical elements comprise surfaces (106, 107) facing towards each other for changing the width of the light distribution pattern in only one direction in response to linearly moving the third optical element with respect to the second optical element.

### FIELD OF THE DISCLOSURE

The disclosure relates generally to illumination engineering. More particularly, the disclosure relates to an optical device for modifying a distribution of light produced by a light source that can be, for example but not necessarily, a light emitting diode “LED”.

### BACKGROUND

A distribution of light produced by a light source can be important or even critical in some applications. The light source can be, for example but not necessarily, a light emitting diode “LED”, a filament lamp, or a gas-discharge lamp. The distribution of light produced by a light source can be modified with optical devices such as lenses, reflectors, and combined lens-reflector devices that comprise sections which act as lenses and sections which act as reflectors. In many cases there is a need for an optical device that is adjustable for tuning a shape of a light distribution pattern produced by a light source and the optical device. For example, there can be a need to change a width of a light distribution pattern smoothly between a narrow light distribution pattern for illuminating a spot and a wider light distribution pattern for illuminating a larger area.

Publication WO2006072885 describes an optical device for adjusting a shape of a light distribution pattern. The optical device of WO2006072885 comprises a first optical element and a second optical element for modifying a distribution of light produced by a light source. The first and second optical elements are successively in a pathway of the light so that the second optical element receives the light exiting the first optical element. Furthermore, the optical device of WO2006072885 comprises an adjustment mechanism for adjusting the distance between the first and second optical elements along the optical axis of the optical device and thereby for varying the light distribution pattern. The optical device of WO2006072885 can modify a light distribution pattern between a narrow light distribution pattern for illuminating a spot and a wider light distribution pattern for illuminating a larger area. The optical device of WO2006072885 is however not capable of changing the shape of the light distribution pattern so that the light distribution pattern is spread or made narrower in a first direction but not in a second direction perpendicular to the first direction.

### SUMMARY

The following presents a simplified summary to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In this document, the word “geometric” when used as a prefix means a geometric concept that is not necessarily a part of any physical object. The geometric concept can be for example a geometric point, a straight or curved geometric line, a geometric plane, a non-planar geometric surface, a geometric space, or any other geometric entity that is zero, one, two, or three dimensional.

In accordance with the invention, there is provided a new optical device for modifying a distribution of light produced by a light source.

An optical device according to the invention comprises:
a first optical element comprising a first surface for modifying a distribution of light exiting the first optical element through the first surface,
a second optical element comprising a second surface facing towards the first surface and for further modifying the distribution of the light entering the second optical element through the second surface and a third surface for further modifying the distribution of light exiting the second optical element through the third surface, and
a third optical element comprising a fourth surface facing towards the third surface and for further modifying the distribution of the light entering the third optical element through the fourth surface.

The first optical element is rotatable with respect to the second optical element around a geometric optical axis of the optical device, and one of the first and second surfaces comprises convex areas and another one of the first and second surfaces comprises concave areas for at least partly compensating for an optical effect of the convex areas when the second optical element is in a first rotational position with respect to the first optical element so that the convex areas and the concave areas are aligned with respect to each other, wherein a combined optical effect of the first and second surfaces is changeable by rotating the first optical element from the first rotational position towards a second rotational position in which the concave areas and the convex areas are non-aligned with respect to each other. The above-mentioned third surface of the second optical element and the fourth surface of the third optical element have grooves so that the grooves of the third surface are parallel with the grooves of the fourth surface, and the third optical element is linearly moveable with respect to the second optical element along a direction of the geometric optical axis of the optical device.

A light distribution pattern produced by a light source and the optical device on a screen perpendicular to the optical axis of the optical device can be modified by rotating the first optical element with respect to the second optical element and by changing a distance between the second and third optical elements. A width of the light distribution pattern is changed in two perpendicular directions by rotating the first optical element with respect to the second optical element, whereas the light distribution pattern is spread or narrowed substantially in one direction only by changing the distance between the second and third optical elements. The “one direction” is a direction which is perpendicular to the optical axis and to the grooves on the above-mentioned third and the fourth surfaces. Thus, the optical device makes it possible to adjust both a size and a shape of a light distribution pattern produced by a light source and the optical device on a screen perpendicular to the optical axis.

In accordance with the invention, there is provided also a new illumination device that comprises:
a light source, and
an optical device according to the invention for modifying a distribution of light emitted by the light source.

The light source may comprise for example one or more light emitting diodes “LED”. In accordance with the invention, there is provided also a new mold set that comprises:
a first mold having a form suitable for manufacturing, by mold casting, a first piece of transparent material constituting the first optical element of an optical device according to the invention,
a second mold having a form suitable for manufacturing, by mold casting, a second piece of transparent material constituting the second optical element of the optical device according to the invention, and
a third mold having a form suitable for manufacturing, by mold casting, a third piece of transparent material constituting the third optical element of the optical device according to the invention.

Exemplifying and non-limiting embodiments are described in accompanied dependent claims.

Various exemplifying and non-limiting embodiments both as to constructions and to methods of operation, together with additional objects and advantages thereof, will be best understood from the following description of specific exemplifying embodiments when read in conjunction with the accompanying drawings.

The verbs “to comprise” and “to include” are used in this document as open limitations that neither exclude nor require the existence of also un-recited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

Exemplifying and non-limiting embodiments and their advantages are explained in greater detail below with reference to the accompanying drawings, in which:

FIGS. 1a and 1b illustrate an illumination device that comprises an optical device according to an exemplifying and non-limiting embodiment, and

FIG. 2 shows exemplifying light distribution patterns produced by the illumination device illustrated in FIGS. 1a and 1b on a screen perpendicular to the geometric optical axis of the optical device.

### DESCRIPTION OF EXEMPLIFYING AND NON-LIMITING EMBODIMENTS

The specific examples provided in the description given below should not be construed as limiting the scope and/or the applicability of the appended claims. Lists and groups of examples provided in the description given below are not exhaustive unless otherwise explicitly stated.

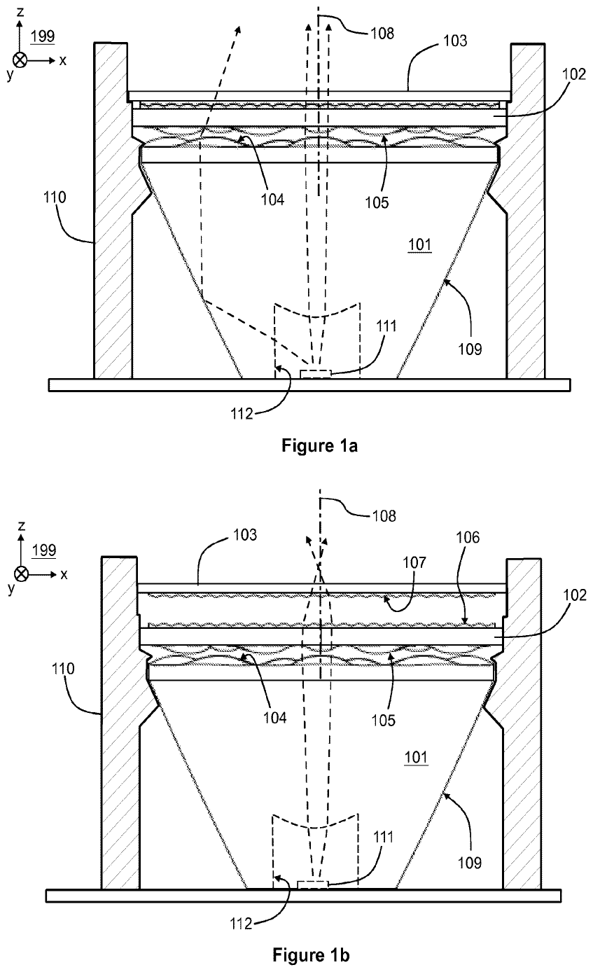

FIGS. 1a and 1b illustrate an illumination device that comprises a light source 111 and an optical device according to an exemplifying and non-limiting embodiment. The optical device comprises a first optical element 101 that comprises a first surface 104 for modifying a distribution of light exiting the first optical element 101 through the first surface 104. In this exemplifying optical device, the first optical element 101 comprises a reflector surface 109 for reflecting light to the above-mentioned first surface 104. The reflector surface 109 is a surface of transparent material for providing total internal reflection “TIR”. The reflector surface 109 and a surface 112 of the first optical element 101 for receiving the light from the light source 111 can be shaped so that the reflected light is substantially collimated light. In FIGS. 1a and 1b, exemplifying light beams are depicted with dashed line arrows.

The optical device comprises a second optical element 102 that comprises a second surface 105 facing towards the above-mentioned first surface 104 and for further modifying the distribution of the light entering the second optical element 102 through the second surface 105. The second optical element 102 comprises a third surface 106 for modifying a distribution of the light exiting the second optical element 102 through the third surface 106. The optical device comprises a third optical element 103 that comprises a fourth surface 107 facing towards the third surface 106 and for further modifying the distribution of the light entering the third optical element 103 through the fourth surface 107. The first, second, and third optical elements 101-103 can be manufactured for example with mold casting. Each of the first, second, and third optical elements 101-103 can be made of for example acrylic plastic, polycarbonate, optical silicone, or glass. It is worth noting that the optical elements 101-103 are not necessarily made of same material.

The first optical element 101 is rotatable with respect to the second optical element 102 around a geometric optical axis of the optical device. In FIGS. 1a and 1b, the geometric optical axis is depicted with a dash-and-dot line 108. The geometric optical axis is parallel with the z-axis of the coordinate system 199. In this exemplifying optical device illustrated in FIGS. 1a and 1b, the above-mentioned first surface 104 of the first optical element 101 comprises convex areas and concave areas between the convex areas. Correspondingly, the above-mentioned second surface 105 of the second optical element 102 comprises convex areas and concave areas between the convex areas. The concave areas of the second surface 105 of the second optical element 102 compensate at least partly for an optical effect of the convex areas of the first surface 104 of the first optical element 101 and, correspondingly, the convex areas of the second surface 105 compensate at least partly for an optical effect of the concave areas of the first surface 104 when the first optical element 101 is in a first rotational position with respect to the second optical element 102 so that the concave areas of the second surface are aligned with the convex areas of the first surface and the convex areas of the second surface are aligned with the concave areas of the first surface. A combined optical effect of the first and second surfaces 104 and 105 is changeable by rotating the first optical element 101 with respect to the second optical element 102 around the geometric optical axis 108 of the optical device.

The third optical element 103 is linearly moveable with respect to the second optical element 102 along a direction of the geometric optical axis 108 of the optical device, i.e. along the z-axis of the coordinate system 199. The third surface 106 of the second optical element 102 and the fourth surface 107 of the third optical element 103 have grooves so that the grooves of the third surface 106 are parallel with the grooves of the fourth surface 107. In this exemplifying optical device illustrated in FIGS. 1a and 1b, the grooves of the fourth surface 107 are shaped to fit to ridges between the grooves of the third surface 106 to substantially nullify a combined optical effect of the third and fourth surfaces 106 and 107 when the third and fourth surfaces 106 and 107 are against each other. In this exemplifying case, the cross-sectional shape of the grooves of the fourth surface 107 is an arc, and, correspondingly, a cross-sectional shape of the ridges between the grooves of the third surface 106 is an arc. Thus, the ridges on the third surface 106 fit to the grooves of the fourth surface 107. It is to be however noted that many different shapes of grooves are applicable in optical devices according to different embodiments of the invention.

The exemplifying optical device illustrated in FIGS. 1a and 1b comprises a frame element 110 for rotatably supporting the first optical element 101 with respect to the second optical element 102 and for moveably supporting the third optical element 103 with respect to the second optical element 102. Depending on an overall implementation of a lighting system, it is also possible that the first, second, and third optical elements of an optical device according to an exemplifying and non-limiting embodiment are mechanically supported by e.g. a frame structure of a light fixture or the like and thus each optical device does not need have an own frame element.

FIG. 1a shows an exemplifying situation in which the above-mentioned third and fourth surfaces 106 and 107 are against each other, and thus the third and the fourth surfaces 106 and 107 do not have any substantial combined optical effect. FIG. 1b shows another exemplifying situation in which the third optical element 103 has been moved in the positive z-direction of the coordinate system 199 away from the second optical element 102. In the exemplifying situation shown in FIG. 1b, the third and the fourth surfaces 106 and 107 spread the light distribution pattern in a direction parallel with the x-axis of the coordinate system 199.

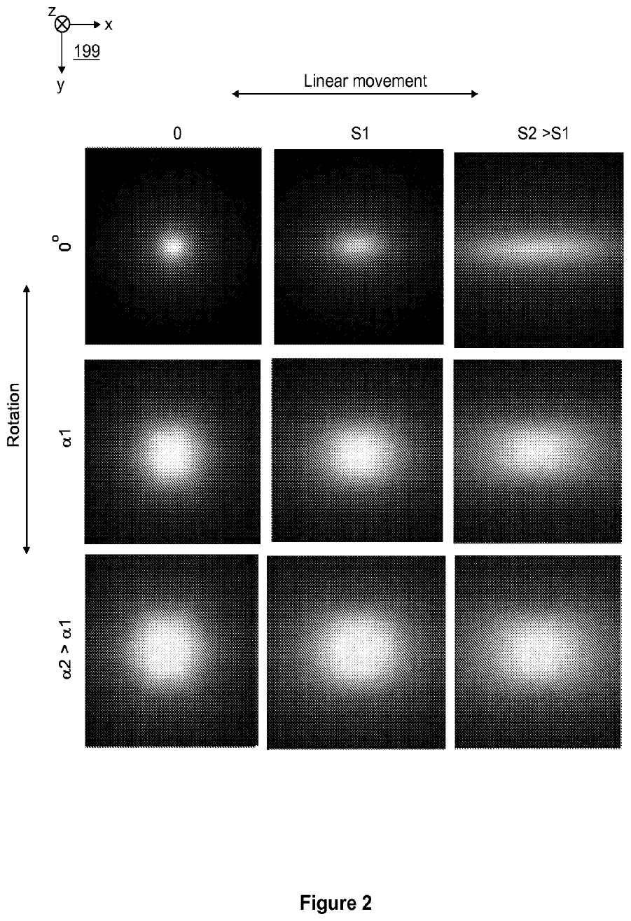

FIG. 2 shows light distribution patterns produced by the illumination device illustrated in FIGS. 1a and 1b on a screen that is perpendicular to the geometric optical axis 108 of the optical device. The left-most column constituted by three light distribution patterns corresponds to a situation in which the third and second optical elements 103 and 102 are against each other and thus the third and the fourth surfaces 106 and 107 do not spread the light distribution pattern in the direction parallel with the x-axis of the coordinate system 199. Therefore, the light distribution pattern is symmetric. The size of the light distribution pattern depends on a rotation angle of the first optical element 101 with respect to the second optical element 101. The sensitivity of the size of the light distribution pattern to the rotation angle depends on sizes and shapes of the concave and convex areas on the first and second surfaces 104 and 105. The first and second surfaces 104 and 105 can be designed for example so that α1 is 15 degrees and a 2 is 30 degrees. The middle column constituted by three light distribution patterns corresponds to a situation in which the third optical element 103 has been shifted away from the second optical 102 by a distance S1. Thus, the third and the fourth surfaces 106 and 107 spread the light distribution pattern in the direction parallel with the x-axis of the coordinate system 199. The right-most column constituted by three light distribution patterns corresponds to a situation in which the third optical element 103 has been shifted away from the second optical 102 by a distance S2 that is greater than S1. Thus, the third and the fourth surfaces 106 and 107 spread the light distribution pattern more than in the situation corresponding to the middle column. The sensitivity of the spreading effect to the shift of the third optical element 103 with respect to the second optical element 102 depends on sizes and shapes of the grooves on the third and the fourth surfaces 106 and 107. The third and the fourth surfaces 106 and 107 can be designed for example so that S1 is 0.3 mm and S2 is 1 mm.

The specific examples provided in the description given above should not be construed as limiting the scope and/or the applicability of the appended claims. Lists and groups of examples provided in the description given above are not exhaustive unless otherwise explicitly stated.

1. An optical device for modifying light distribution, the optical device comprising:
a first optical element comprising a first surface for modifying a distribution of light exiting the first optical element through the first surface, and
a second optical element comprising a second surface facing towards the first surface and for further modifying the distribution of the light entering the second optical element through the second surface and a third surface for further modifying the distribution of the light exiting the second optical element through the third surface,
wherein the first optical element is rotatable with respect to the second optical element around a geometric optical axis of the optical device, and one of the first and second surfaces comprises convex areas and another one of the first and second surfaces comprises concave areas for at least partly compensating for an optical effect of the convex areas when the second optical element is in a first rotational position with respect to the first optical element so that the convex areas and the concave areas are aligned with respect to each other, wherein a combined optical effect of the first and second surfaces is changeable by rotating the first optical element from the first rotational position towards a second rotational position in which the concave areas and the convex areas are non-aligned with respect to each other, and wherein the optical device comprises a third optical element comprising a fourth surface facing towards the third surface of the second optical element, wherein the third and the fourth surfaces have grooves so that the grooves of the third surface are parallel with the grooves of the fourth surface, and the third optical element is linearly moveable with respect to the second optical element along a direction of the geometric optical axis of the optical device.

2. An optical device according to claim 1, wherein the grooves of the fourth surface are shaped to fit to ridges between the grooves of the third surface to nullify a combined optical effect of the third and fourth surfaces when the third and fourth surfaces are against each other.

3. An optical device according to claim 1, wherein the first surface comprises the convex areas, the second surface comprises the concave areas, the first surface comprises other concave areas between the convex areas of the first surface, and the second surface comprises other convex areas between the concave areas of the second surface.

4. An optical device according to claim 1, wherein the first optical element comprises a reflector surface for reflecting the light to the first surface.

5. An optical device according to claim 4, wherein the reflector surface and a surface of the first optical element for receiving the light from a point-form light source are shaped so that the reflected light is collimated light.

6. An optical device according to claim 4, wherein the reflector surface is a surface of transparent material for providing total internal reflection.

7. An optical device according to claim 1, wherein each of the first optical element, the second optical element, and the third optical element is made of one of the following: acrylic plastic, polycarbonate, optical silicone, glass.

8. An optical device according to claim 1, wherein a cross-sectional shape of the grooves of the fourth surface is an arc, and a cross-sectional shape of ridges between the grooves of the third surface is an arc.

9. An optical device according to claim 1, wherein the optical device comprises a frame element for rotatably supporting the first optical element with respect to the second optical element and for moveably supporting the third optical element with respect to the second optical element.

10. A set of molds comprising:
a first mold having a form suitable for manufacturing, by mold casting, a first piece of transparent material constituting a first optical element of an optical device,
a second mold having a form suitable for manufacturing, by mold casting, a second piece of transparent material constituting a second optical element of the optical device, and
a third mold having a form suitable for manufacturing, by mold casting, a third piece of transparent material constituting a third optical element of the optical device, wherein:
the first optical element comprises a first surface for modifying a distribution of light exiting the first optical element through the first surface, and
the second optical element comprises a second surface facing towards the first surface and for further modifying the distribution of the light entering the second optical element through the second surface and a third surface for further modifying the distribution of the light exiting the second optical element through the third surface,
wherein the first optical element is rotatable with respect to the second optical element around a geometric optical axis of the optical device, and one of the first and second surfaces comprises convex areas and another one of the first and second surfaces comprises concave areas for at least partly compensating for an optical effect of the convex areas when the second optical element is in a first rotational position with respect to the first optical element so that the convex areas and the concave areas are aligned with respect to each other, wherein a combined optical effect of the first and second surfaces is changeable by rotating the first optical element from the first rotational position towards a second rotational position in which the concave areas and the convex areas are non-aligned with respect to each other, and wherein the third optical element comprises a fourth surface facing towards the third surface of the second optical element, wherein the third and the fourth surfaces have grooves so that the grooves of the third surface are parallel with the grooves of the fourth surface, and the third optical element is linearly moveable with respect to the second optical element along a direction of the geometric optical axis of the optical device.

11. An illumination device comprising:
a light source, and
an optical device for modifying a distribution of light emitted by the light source,
wherein the optical device comprises:
a first optical element comprising a first surface for modifying a distribution of light exiting the first optical element through the first surface, and
a second optical element comprising a second surface facing towards the first surface and for further modifying the distribution of the light entering the second optical element through the second surface and a third surface for further modifying the distribution of the light exiting the second optical element through the third surface,
wherein the first optical element is rotatable with respect to the second optical element around a geometric optical axis of the optical device, and one of the first and second surfaces comprises convex areas and another one of the first and second surfaces comprises concave areas for at least partly compensating for an optical effect of the convex areas when the second optical element is in a first rotational position with respect to the first optical element so that the convex areas and the concave areas are aligned with respect to each other, wherein a combined optical effect of the first and second surfaces is changeable by rotating the first optical element from the first rotational position towards a second rotational position in which the concave areas and the convex areas are non-aligned with respect to each other, and wherein the optical device comprises a third optical element comprising a fourth surface facing towards the third surface of the second optical element, wherein the third and the fourth surfaces have grooves so that the grooves of the third surface are parallel with the grooves of the fourth surface, and the third optical element is linearly moveable with respect to the second optical element along a direction of the geometric optical axis of the optical device.

12. An optical device according to claim 2, wherein the first surface comprises the convex areas, the second surface comprises the concave areas, the first surface comprises other concave areas between the convex areas of the first surface, and the second surface comprises other convex areas between the concave areas of the second surface.

13. An optical device according to claim 2, wherein the first optical element comprises a reflector surface for reflecting the light to the first surface.

14. An optical device according to claim 3, wherein the first optical element comprises a reflector surface for reflecting the light to the first surface.

15. An optical device according to claim 13, wherein the reflector surface and a surface of the first optical element for receiving the light from a point-form light source are shaped so that the reflected light is collimated light.

16. An optical device according to claim 14, wherein the reflector surface and a surface of the first optical element for receiving the light from a point-form light source are shaped so that the reflected light is collimated light.

17. An optical device according to claim 5, wherein the reflector surface is a surface of transparent material for providing total internal reflection.

18. An optical device according to claim 13, wherein the reflector surface is a surface of transparent material for providing total internal reflection.

19. An optical device according to claim 14, wherein the reflector surface is a surface of transparent material for providing total internal reflection.

20. An optical device according to claim 15, wherein the reflector surface is a surface of transparent material for providing total internal reflection
